(19) United States
(12) Patent Application Publication
(10) Pub. No.: US 2005/0265268 A1
(43) Pub. Date: Dec. 1, 2005

(54) Return link adaptation algorithm

(76) Inventors: Lars Erup, Saint-Lazare (CA); James Malcolm Keelty, Beaconsfield (CA)

Correspondence Address: Edward F. Behm, Jr.;2500 One Liberty Place, 1650 Market Street, Philadelphia, PA, 19103, US

(21) Appl. No.: 11/117,652

(22) Filed: Apr. 28, 2005

Related U.S. Application Data
(60) Provisional application No. 60/565,925, filed on Apr. 28, 2004.

(51) Int. Cl. H04B 7/00

(52) U.S. Cl. 370/310

(57) ABSTRACT

An apparatus, system, and method of improving the E_{S}/N₀ ratio performance of a wireless device. The apparatus, system, and method include measuring an E_{S}/N₀ ratio in a communicated return link burst, and, upon failure of the E_{S}/N₀ ratio to meet a predetermined threshold, probing for an available switch to a less protested communication mode to improve the E_{S}/N₀ ratio. The probing may include transmitting a full power SYNC burst, measuring the E_{S}/N₀ ratio correspondent to the full power SYNC burst, and comparing the measured E_{S}/N₀ ratio correspondent to the full power SYNC burst to the predetermined threshold.

### CROSS-REFERENCE TO RELATED APPLICATIONS

This application is claims priority to U.S. Patent Application Ser. No. 60/565,925 entitled “Return Link Adaptation Algorithm”, filed Apr. 28, 2004 with named inventor Lars Erup, which application is hereby incorporated herein as if set forth in the entirety.

### FIELD OF THE INVENTION

This invention relates generally to an algorithm, and, more particularly, to an apparatus, system, and method for selecting transmission modes in a DVB-RCS return link that employs adaptive modulation and coding.

### BACKGROUND OF THE INVENTION

While the present invention is described, for illustrative purposes, as being applied to DVB-RCS systems, it will be understood that it can be employed in any system that employs adaptive modulation and coding.

Despite the current global economic downturn, Internet usage and bandwidth needs continues to grow. Broadband access will play an integral role in serving this demand. Digital subscriber line (DSL) and cable modem technologies are currently dominating the market for broadband access, with emerging competition from satellite wireless technologies.

The significant capital cost of DSL and cable modem infrastructure rollouts has to date constrained broadband service availability. In addition, technical limitations of DSL (e.g. distance from central office) and cable modems (e.g. shared line capacity) have led to service degradation, which in turn has resulted in slower customer acceptance. Given rapid growth in market demand and the limitations of existing technologies, satellite broadband access has emerged as another technology with particular advantages. Satellite broadband access has been available for a number of years, but has addressed only a very limited market because of the cost of terminal equipment.

For the last fifteen years, the legacy very small aperture terminal (VSAT) industry has provided thin-route services based on the limited data rate capabilities of the prevailing platforms. The industry has experienced considerable consolidation, and is today dominated by two players: Hughes Network Systems (HNS) and Gilat Satellite Networks. Each uses its own proprietary equipment, and each company is increasingly focused on services instead of equipment sales. As the installed base of VSAT subscribers (currently approximately 600,000) strains the limits of existing systems, both HNS and Gilat are actively researching ways to cost-effectively extend the platform capabilities to address the consumer access market. Although these vendors have alternative solutions for extending forward-channel (from a central site to the remote users) data rates, they are still working on a corresponding extension of return channel capabilities. Current implementations are limited to 256 kb/s return channels, each shared by multiple subscribers.

With the primary VSAT market providing services well below an average of 64 kb/s to each subscriber, a number of niche players have attempted to offer higher speed TDMA solutions for more bandwidth-intensive applications, including mixtures of high-speed Internet access, voice/fax, videoconferencing, and trunking. Companies addressing this market including Comstream (with their VSAT Plus product, now part of a Canadian company NSI), COMSAT Labs (now part of Viasat), and Nortel DASA (now known as ND SatCom).

The emerging satellite broadband access market was driven in the late 1990's by the vision of infrastructure architects such as Astrolink, Teledesic, SkuBridge, SES/Astra, HNS SpaceWay, Wild Blue (formerly iSky), and a short list of others with access to considerable technical and capital resources. These new infrastructures were intended to drop service cost per user by an order of magnitude compared to legacy VSAT products, while providing a order of magnitude greater bandwidth. Of the several new technologies and architectures proposed, only the Digital Video Broadcast-Return Channel System (DVB-RCS) open standard has clearly survived. Dozens of companies have embraced the open standard's promise of accelerating economies of scale, thereby generating lower-cost solutions and opening the market in a shorter timeframe than could be possible with competing proprietary solutions.

The DVB-RCS open standard provides a return channel via satellite to systems based on the DVB standard. It is published and maintained by the European Telecommunications Standards Institute (ETSI standard EN 301 790). The DVB-RCS standard is tailored to the specific nuances of Internet access over a Geosynchronous Satellite—namely, propagation delay, rain fade, and/or Doppler affects.

In order to successfully implement the DVB-RCS standard, and reap the benefits, the industry must seriously focus on several area; regulatory issues, Outdoor Uniit (ODU) RF/Antenna costs, InDoor Unit (IDU) Baseband costs, and interoperable standardized Hubs/Gateways.

At present, the quality and quantity of satellite access systems has been limited by the cost and size of RF/ODU technology and baseband/IDU technology. With new manufacturing techniques and advanced antenna designs, the cost of the antenna and transmitter unit has decreased considerably over the past several years.

With the cost of the ODU declining, overall cost reduction necessitates a movement towards solutions to improve price and performance of the DVB-RCS system.

Accordingly, a need exists for an improved method of for selecting transmission modes in a DVB-RCS return link that employs adaptive modulation and coding. Further, there is a need for a apparatus, system, and method for improving the E_{S}/N₀ ratio performance of a wireless device in a wireless communication mode.

### SUMMARY OF THE INVENTION

The present invention includes an apparatus, system, and method of improving the E_{S}/N₀ ratio performance of a wireless device in a wireless communication mode. The apparatus, system, and method include measuring an E_{S}/N₀ ratio in a communicated return link burst, and, upon failure of the E_{S}/N₀ ratio to meet a predetermined threshold, probing for an available switch to a less protested, communication mode to improve the E_{S}/N₀ ratio. The probing may include transmitting a full power SYNC burst, measuring the E_{S}/N₀ ratio correspondent to the full power SYNC burst, and comparing the measured E_{S}/N₀ ratio correspondent to the full power SYNC burst to the predetermined threshold.

### BRIEF DESCRIPTION OF THE FIGURES

Understanding of the present invention will be facilitated by consideration of the following detailed description of the present invention taken in conjunction with the accompanying drawings, in which like numerals refer to like parts, and wherein:

FIG. 1 is a diagram illustrating improving the E_{S}/N₀ ratio performance of a wireless system;

FIG. 2 is a diagram illustrating fading and mode selection of the present invention;

FIG. 3 is a diagram illustrating estimated and reported E_{S}/N₀ of the present invention;

FIG. 4 is a diagram illustrating actual and threshold C/N₀ of the present invention; and

FIG. 5 is a diagram illustrating output back off of the present invention.

Although the drawings represent an embodiment of the present invention, the drawings are not necessarily to scale and certain features may be exaggerated in order to better illustrate and explain the present invention.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical antenna applications, and systems and methods of using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Fundamentally, the algorithm acts on the measured E_{S}/N₀ in the return link bursts. When this falls below the threshold value for the current transmission mode, it is assumed that a fade event is in progress and a more protected mode is selected (if available). When not in the least-protected (“clear-weather”) mode, the algorithm periodically “probes” whether a switch to a less protected mode is possible. A switch is performed if this appears to be the case. The probe is carried out by forcing the terminal to transmit a SYNC burst at full power, measuring the corresponding E_{S}/N₀. and comparing the result to the threshold for the next-less protected mode. (With suitable normalization; actual comparisons are most easily done in terms of C/N₀.)

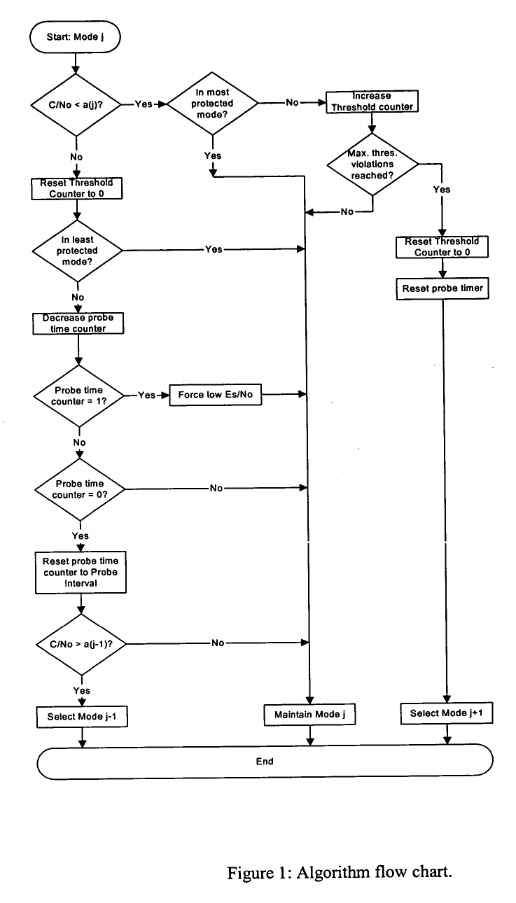

A flowchart of the algorithm is shown in FIG. 1. The algorithm is executed for each SYNC burst for each terminal, except that it should not be executed while a mode switching is in progress. Two counters are employed: The “Threshold counter” and the “Probe Time” counter. The “Probe Time” counter is decremented each multiframe. When it reaches the value 1, a probe is requested. The probe is received in the next multiframe, when the counter has the value 0. The “Probe Time” counter is reset to the desired probe interval (e.g., 5 multiframes) after each probe. This counter is not active when the terminal is in the “clear weather” mode.

The second counter keeps track of the number of successive measurements that fall below the threshold signal quality for the current mode. A down-switch initiated only when a pre-set number of measurements do this (Typically 2 or 3 measurements).

Other parameters include the set of C/N₀ thresholds a(j), corresponding to the various transmission modes. j=1 corresponds to the “clear weather” mode; remaining modes are defined in order of increasing protection.

Requiring that the terminals be able to determine their operating point can have serious cost impacts. An algorithm that operates without explicit determination of this is therefore very attractive. This algorithm measures not the operating point, but the signal quality that can be achieved at any time, if the terminal operates at full power.

Down-switching (to a more protected mode) should be carried out quickly, once a fade is detected. If this is not done, the link can be lost. However, because of the use of power control, the link will always be operating close to this threshold. Therefore, in order to avoid spurious “excursions” from the clear-weather mode during periods without fading, a counter mechanism is introduced, in an to attempt to ensure that the power control is really exhausted before a down-switching is performed.

Up-switching (to a less protected mode) is a little less critical. There is no risk of losing the link even if this process is delayed. However, the less protected modes typically have either better quality (higher data rate) or use less bandwidth (or both). It is therefore of course attractive to up-switch expediently.

In this algorithm, up-switching can occur only immediately following a probe. Purely from the point of view of using the best possible mode, the probing should therefore be frequent. However, this will increase the system interference (see below). Also, previous investigations have indicated that a “dead time” following a down-switching is a good way of avoiding equivocation (ping-pong effect) between two modes, when the condition is close to the threshold between them. Therefore, a moderate interval (e.g., 5 seconds) between probes is appropriate. This rate of “sampling” the fade event is sufficiently fast at Ka-band, where fade durations are very rarely shorter than about 10 seconds.

The use of the higher power SYNC burst will of course increase the system interference. However, in a practical system, this increase is negligible. A typical average data rate for an active terminal is 10 kb/s (depending on traffic models). A SYNC burst every 0.85 seconds (every 32 frames with a frame duration of 26.5 ms) corresponds to 0.25 kb/s. With these numbers, SYNC bursts occupy 2.5% of the capacity. Assume further that 90% of the traffic is in clear weather mode (a conservative assumption) and that one in 5 SYNC bursts in the non-clear-weather modes is transmitted at full power. With these assumptions, bursts corresponding to 0.05% of the total capacity are transmitted with extra power.

The “step” between successive modes will typically be around 3 dB. As a conservative assumption, let's say that the “probe” SYNC bursts are transmitted with 5 dB more power than the regular bursts. The total interference in the system will then increase by 10log₁₀(1+5×10⁻⁴×10^{0.5})=0.007 dB.

This section presents some simulation results that illustrate the operation of the algorithm. The system modeled is similar to Anik-F2. Three transmission modes are used, requiring C/N₀ of 62.6, 58.6 and 55.6 dBHz, respectively. The fade events simulated have slopes in excess of the 0.3 dB/s that is normally considered the maximum encountered at 30 GHz. Power control was operational in the simulation; no fade on the “feeder link” between satellite and hub was simulated. The calculation carried out at each time step was a complete link budget, taking into account the current fade and the reported E_{S}/N₀. The calculation included co-polar and cross-polar interference, including effects of rain-induced depolarization.

The time necessary to carry out a mode switching was not modeled directly. However, the detection/decision algorithm should not be operated during switchovers. The effect of this simplification is therefore effectively a small time discontinuity at each switch operation; it does not affect the overall algorithm behavior.

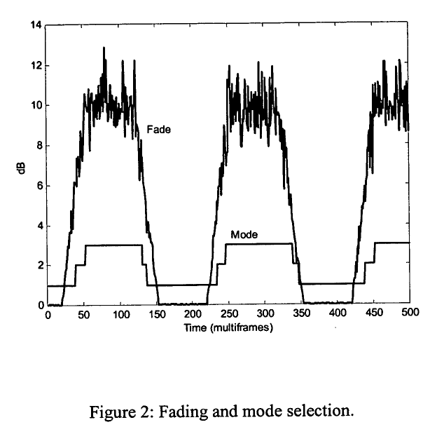

FIG. 2 shows the fading and the corresponding selection of transmission mode vs. time. The time is measured in multiframes, i.e., the period between successive SYNC bursts. The mode selection is presented as an index, where “1” corresponds to the clear-weather mode, and “3” represents the most protected mode. It can be seen that the mode selection follows the fading.

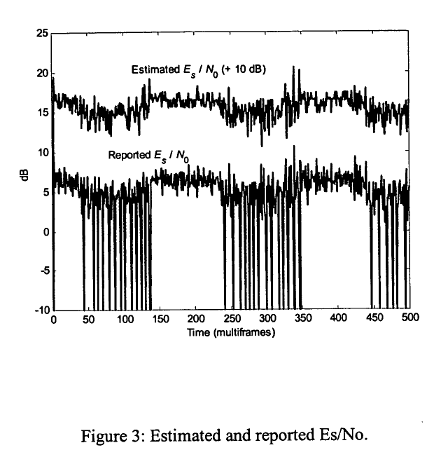

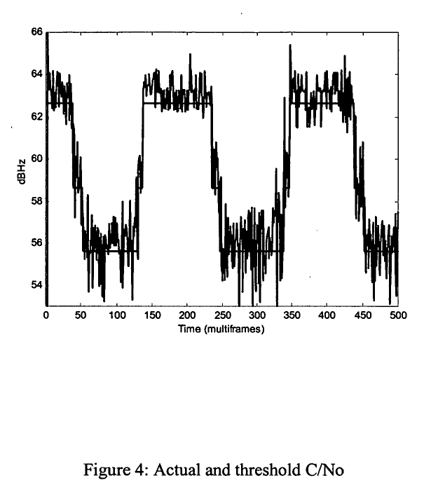

The probing process is illustrated in FIG. 3. This figure shows the estimated and reported E_{S}/N₀. The estimated values are offset by 10 dB, to separate the curves. The reported values are generally the same, except that when in modes other than “clear-weather”, the full-power probes are requested by transmitting an artificially low value. (In EMS' implementation of DVB-RCS, the forward link signaling implementing closed loop power control is the E_{S}/N₀ value estimated at the hub.) FIG. 4 shows the estimated C/N₀ and the threshold corresponding to the current mode, as a function of time. It can be seen that these track appropriately.

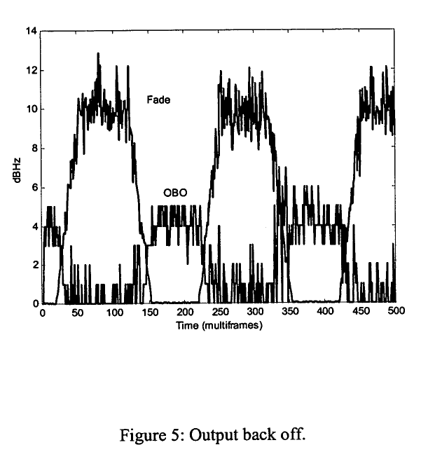

The output back off of the terminal behaves as expected. FIG. 5 shows the relationship between this parameter (which is not known explicitly in the real system, and thus not used in the algorithm) and the fading. It can be seen that the OBO quickly drops to zero during fade events and stays close to that value, while the rest of the fade is handled by changing transmission mode. Similarly, the OBO settles at a value which allows use of the least protected mode during clear weather, with only a small margin (FIG. 4-FIG. 5).

The algorithm can operate with no modifications to a standard terminal. However, operations can be optimized if the terminal is aware of the probing process. If the terminal is aware that a particular E_{S}/N₀ report is really a probe, it can transmit just the SYNC burst at full power, and for example leave traffic at the ordinary level. To achieve this, a particular value should always be used for the “probe” report. It is suggested to use the value 40_{HEX}, corresponding to an E_{S}/N₀ of −32 dB. This is the minimum value that can be transmitted using the DVB-RCS signaling. When this value is received, the terminal should ignore any smoothing or other processing it may perform, and transmit the next SYNC burst at full power.

However, even terminals that are not “probe-aware” will transmit the next SYNC burst at full or nearly full power when this value if received. The method is therefore usable with all compliant terminals.

The embodiments disclosed above are not intended to be exhaustive or to limit the invention to the precise forms disclosed in the detailed description. Rather, the embodiments have been chosen and described so that others skilled in the art may utilize their teachings. Although described in the exemplary embodiments, it will be understood that various modifications may be made to the subject matter without departing from the intended and proper scope of the invention.

1. A method of communication by a wireless terminal, comprising:
measuring an E_{S}/N₀ ratio in a communicated return link burst;
upon failure of the E_{S}/N₀ ratio to meet a predetermined threshold, probing for an available switch to a less protested communication mode to improve the E_{S}/N₀ ratio;
wherein said probing includes transmitting a full power SYNC burst, measuring the E_{S}/N₀ ratio correspondent to the full power SYNC burst, and comparing the measured E_{S}/N₀ ratio correspondent to the full power SYNC burst to the predetermined threshold.
